(19) United States
(12) Patent Application Publication
(10) Pub. No.: US 2004/0118885 A1
(43) Pub. Date: Jun. 24, 2004

(54) Clip assist for visors

(76) Inventor: Thomas E. Turner, Shelby Twp., MI (US)

Correspondence Address: Thomas A. Jurecko, DaimlerChrysler Intellectual Capital Corporation, CIMS 483-02-19, 800 Chrysler Drive, Auburn Hills, MI, 48326-2757, US

(21) Appl. No.: 10/325,219

(22) Filed: Dec. 20, 2002

(51) Int. Cl. B60R 7/00; B60R 7/05

(52) U.S. Cl. 224/312; 224/929

(57) ABSTRACT

The invention is a sun visor assembly having a visor body with a main body portion of a certain thickness generally throughout the main body portion. An outer edge extends along and defines the profile of the main body portion. An area of indentation preferably extends from the outer edge inwardly toward the main body portion of the visor body. This area of indentation is preferably rectangular in shape and is generally of a thickness less than the thickness of the main body portion. This indentation provides a sun visor assembly that assists in preventing a clip-on assembly from sliding off the visor.

### FIELD OF THE INVENTION

The present invention generally relates to sun visors for vehicles. More particularly, the present invention relates to a sun visor having an area for supporting and securing a clip-on object.

### BACKGROUND OF THE INVENTION

It is known to equip motor vehicles with sun visors for blocking the sunlight shining through the windshield. In addition to this main purpose, these visors are used to hold various items such as garage door openers, CD or tape holders, or sun glasses for example. A disadvantage to using the sun visor as a storage device is that the rounded main body of the visor has a tendency to force a clip-on object off the edge. For example, a garage door opener may be provided with a clip-on assembly for removably attaching the opener to the visor edge. Because the visor is generally oval in shape, the clip tends to slide off the rounded main body portion of the visor.

Many adaptations to the visor have been proposed to hold such goods. U.S. Pat. No. 5,951,090 to Wilson et al., issued Sep. 14, 1999 and entitled “Sun Visor with Retractable Article—Holding Assembly,” for example, teaches a modified sun visor including an adjustable nonrealistic strap. The disadvantage of this strap is that it requires extensive modification in design and manufacture of the standard sun visor.

Other modifications have been to add an overhead console for supporting several items such as that taught by U.S. Pat. No. 5,887,929 to Miller, et al., issued Mar. 30, 1999 and entitled “Garage Door Opener Bin.” Again, the disadvantage is the extensive modification in design and manufacturing required.

U.S. Pat. No. 5,516,018 to Eskandry, issued May 14, 1996 and entitled “Multi-Function Automobile Visor Unit” and U.S. Pat. No. 5,653,364 to Eskandry, issued Aug. 5, 1997 and entitled “Multi-Function Automobile Visor Unit with CD Holder” are other examples of accessory carriers developed as after-market visors that may be mounted on a sun visor. A disadvantage of these carriers is that they must be purchased separately and attached over the existing visor within the vehicle.

U.S. Pat. No. 5,489,078 to Risley, issued Feb. 6, 1996 and entitled “Container Clip” amends the clip assembly to support a round moist snuff container. The disadvantage of this clip is that the portion attachable to the visor is a standard clip and does not eliminate the tendency of the clip to slide off the rounded main body portion of the visor.

### SUMMARY OF THE INVENTION

The invention is a sun visor assembly having a visor body with a main body portion of a certain thickness generally throughout the main body portion. An outer edge extends along and defines the profile of the main body portion. An area of indentation preferably extends from the outer edge inwardly toward the main body portion of the visor body. This area of indentation is preferably rectangular in shape and is generally of a thickness less than the thickness of the main body portion. This indentation provides a sun visor assembly that assists in preventing a clip-on assembly from sliding off the visor.

Accordingly, it is an object of this invention to provide a sun visor that assists in holding a device on the visor without requiring a modified clip assembly.

It is another object of the invention to provide a standard visor with an area of indentation for supporting clip-on devices without requiring major modification to the design and manufacture of the visor assembly.

It is still another object of the invention to provide a sun visor assembly for assisting in supporting clip-on devices that comes equipped with the vehicle.

Further areas of applicability of the present invention will become apparent from the detailed description provided hereinafter. It should be understood that the detailed description and specific examples, while indicating the preferred embodiment of the invention, are intended for purposes of illustration only and are not intended to limited the scope of the invention.

### BRIEF DESCRIPTION OF THE DRAWINGS

The present invention will become more fully understood from the detailed description and the accompanying drawings, wherein:

FIG. 1 is a front elevation view of a sun visor assembly of the prior art.

FIG. 2 is a cross-sectional view taken along line 2-2 of FIG. 1, showing the tendency of a clip-on assembly to slide off the front edge of the sun visor assembly of the prior art.

FIG. 3 is a front elevation view of a sun visor assembly of the present invention.

FIG. 4 is a cross-sectional view taken along line 4-4 of FIG. 3, showing the tendency of a clip-on assembly maintain its position on the sun visor assembly of the present invention.

### DETAILED DESCRIPTION OF THE PREFERRED EMBODIMENTS

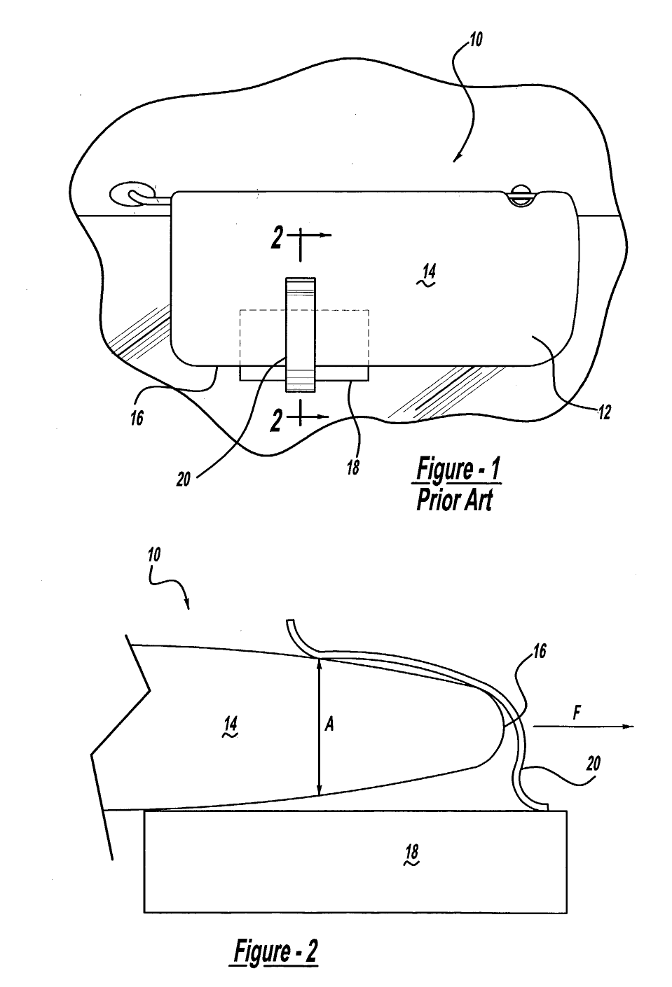

With reference to FIGS. 1 and 2, a sun visor assembly 10 that is well known in the art is there shown and indicated as PRIOR ART in the drawings. This prior art sun visor 10 is generally formed with a visor body 12 having a main body portion 14 of a certain thickness A throughout. An outer edge 16 extends along the periphery of the main body portion 14 and defines the profile of the sun visor assembly 10. The thickness A of the main body portion 14 is less at the outer edge 16 of the visor body 12, and generally forms a rounded edge. An item, such as a garage door opener 18, is shown attached to the visor body 12 by clip 20. The clip 20 holds the garage door opener 18 in place by tension on the visor body 12. Because the main body portion 14 has a thickness A that is greater then the outer edge 16 of the visor body 12 and the visor body 12 is generally rounded, the tensioned clip 20 has a tendency to close toward the garage door opener 18 resulting in a sliding force F (as shown in FIG. 2) of the garage door opener 18 away from the visor body 12 and off the outer edge 16 of the sun visor assembly 10. The garage door opener 18 successfully slips off the sun visor assembly 10 and falls down into a vehicle from its desired position.

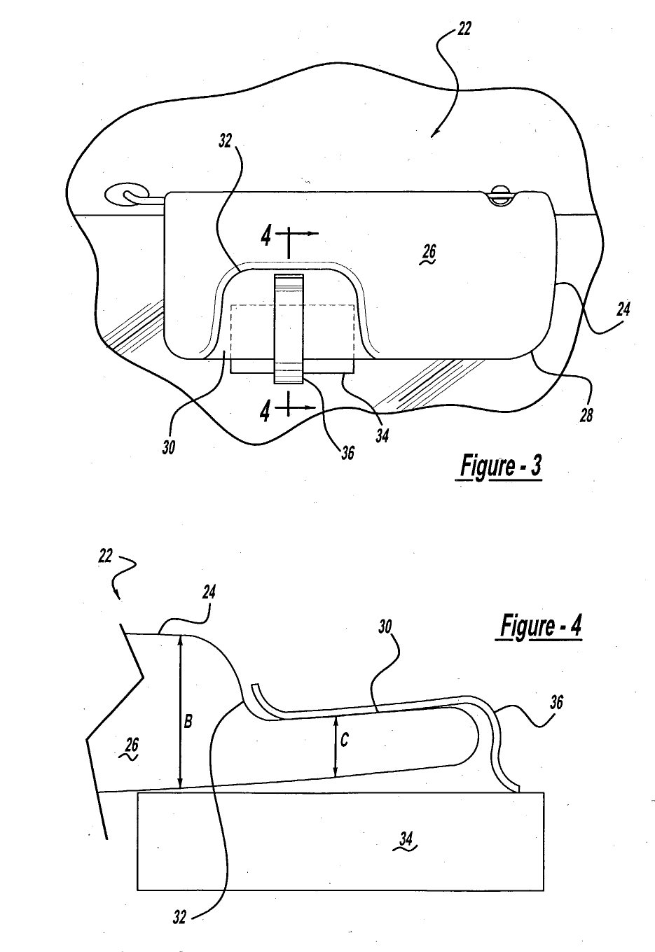

With reference to FIGS. 3 and 4, a preferred embodiment of the present invention is there shown. A sun visor assembly 22 includes a visor body 24 having a main body portion 26 formed with a certain thickness B. An outer edge 28 extends along the periphery of the main body portion 26 and defines the profile of the sun visor assembly 22 of the present invention. In accordance with the present invention, the main body is formed so that at least an area thereof has a reduced thickness. This area of reduced thickness is denoted as an area of indentation 30 extending from the outer edge 28 inwardly toward the main body portion 26 and is generally defined by inner edge 32 and outer edge 28. As is best shown in FIG. 4, this area of indentation 30 is formed having a thickness C less than the certain thickness B of the main body portion 26. An item, such as a garage door opener 34, is shown attached to the visor body 24 by clip 36. The clip 36 holds the garage door opener 34 in place by tension on the visor body 24. Also shown in FIG. 4, the area of reduced thickness has a contour such that the reduced area of thickness is angled relative to a surface on the opposite face of the main body.

Unlike the prior art shown in FIGS. 1 and 2, the area of indentation 30 eliminates any forces tending to push the garage door opener 34 off the outer edge 28 of the sun visor assembly 22. Because the clip 36 is opened less to slide about the area of indentation 30 with thickness C, the inherent spring tension on the clip 36 is also less, thereby reducing its tendency to close toward the garage door opener 34. The garage door opener 34 will successfully maintain its position on the sun visor assembly 22 when placed within the area of indentation 30.

While the invention has been described in the specification and illustrated in the drawings with reference to a preferred embodiment, it will be understood by those skilled in the art that various changes may be made and equivalents may be substituted for elements thereof without departing from the scope of the invention as defined in the claims. In addition, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the description of the appended claims.

What is claimed is:

1. A sun visor for a vehicle comprising:
a main body portion having an area of reduced thickness extending to an outer edge of the main body, wherein the thickness of the reduced area is arranged to receive a clip-on device.

2. The sun visor of claim 1, wherein the area of reduced thickness and the outer edge have an equal thickness, and the equal thickness is less than a thickness of the main body.

3. The sun visor of claim 1, wherein the area of reduced thickness comprises a generally rectangularly shaped face surface for supporting a clip about the outer edge of the visor.

4. The sun visor of claim 1, wherein the area of reduced thickness has a uniform flat surface.

5. The sun visor of claim 1, the area of reduced thickness having a contour such that the reduced area of thickness is angled relative to a surface on an opposite face of the main body.

6. The sun visor of claim 1, wherein the visor includes a plurality of separate areas of reduced thickness.
